(19) United States
(12) Patent Application Publication
(10) Pub. No.: US 2024/0289664 A1
(43) Pub. Date: Aug. 29, 2024

(54) METHOD AND APPARATUS FOR PROCESSING A DATA SIMULATION TASK, ELECTRONIC DEVICE, AND STORAGE MEDIUM

(71) Applicant: Origin Quantum Computing Technology (Hefei) Co., Ltd, Hefei (CN)

(72) Inventors: Yuan FANG, Hefei (CN); Boying CHEN, Hefei (CN); Jing WANG, Hefei (CN); Menghan DOU, Hefei (CN)

(73) Assignee: Origin Quantum Computing Technology (Hefei) Co., Ltd, Hefei (CN)

(21) Appl. No.: 18/652,191

(22) Filed: May 1, 2024

Related U.S. Application Data
(63) Continuation of application No. PCT/CN2023/079746, filed on Mar. 6, 2023.

(30) Foreign Application Priority Data
Mar. 11, 2022 (CN) 202210241533.3
Mar. 11, 2022 (CN) 202210241535.2
Mar. 11, 2022 (CN) 202210241553.0

(51) Int. Cl. G06N 10/20

(52) U.S. Cl. CPC G06N 10/20

(57) ABSTRACT

Disclosed are a method and an apparatus for processing a data simulation task, an electronic device, and a storage medium. The method includes: obtaining target data of a data simulation task, where the data simulation task is simulating Hamiltonian; performing an operation process based on the target data and a specified operation condition, to obtain computing data of the data simulation task; decomposing the computing data into a set of finite number of quantum gates; and constructing, based on the set of the finite number of quantum gates, a quantum circuit to perform simulation, and in a case that a similarity between a circuit matrix corresponding to the quantum circuit and the computing data meets a specified condition, using simulated data obtained through simulation based on the quantum circuit as the target data.

### CROSS-REFERENCE TO RELATED APPLICATIONS

This application is a continuation of International Application No. PCT/CN2023/079746, filed on Mar. 6, 2023, which claims priority to Chinese Patent Application No. 202210241535.2, filed on Mar. 11, 2022, Chinese Patent Application No. 202210241533.3 filed on Mar. 11, 2022, and Chinese Patent Application No. 202210241553.0, filed on Mar. 11, 2022. The disclosures of the aforementioned applications are hereby incorporated by reference in their entireties.

### TECHNICAL FIELD

Embodiments of this application relate to the field of data processing, and in particular, to a method and an apparatus for processing a data simulation task, an electronic device, and a storage medium.

### BACKGROUND

In the field of data processing, data may be used to simulate a transaction in the real world by establishing a data simulation task, initial data is input and a processing process of the data simulation task is executed to obtain output data, thereby implementing simulation of a change process of the transaction in the real world.

Energy of a system in quantum mechanics is described by using a Hamiltonian operator H, to solve all or some of properties of Hamiltonian of a given system, thereby constituting core problems of a series of disciplines such as condensed state physics, computational chemistry, and high energy physics. Quantum simulation has a wide range of applications: research on multi-body localization, time crystals, high-temperature superconductivity, and topological order in condensed state physics; molecular dynamics simulation and reaction simulation in quantum chemistry; field theory simulation in high energy physics; and even related research in nuclear physics and cosmology.

However, a degree of freedom of a system increases exponentially with an increase of the system, and thus a classical computer generally fails to be used to effectively simulate a quantum system.

Quantum computers are physical apparatuses that perform high-speed mathematical and logical operations as well as store and process quantum information in accordance with laws of quantum mechanics. An apparatus is a quantum computer if the apparatus processes and computes quantum information and runs a quantum algorithm. Thus, quantum computers have the ability to deal with mathematical problems more efficiently than ordinary computers.

Therefore, there is a need to provide a method for performing digital quantum simulation on a general-purpose quantum computer, that is, using a quantum gate to construct a quantum circuit for quantum simulation.

### SUMMARY

Implementations of this application provide a method and an apparatus for processing a data simulation task, an electronic device, and a storage medium, to solve a problem that it is difficult to simulate a Hamiltonian of a quantum mechanical system by using a classical computer.

An implementation in this application provides a method for processing a data simulation task, and the method includes: obtaining target data of a data simulation task, where the data simulation task is simulating Hamiltonian; and the target data is Hamiltonian H, and H is represented in a square matrix form and is independent of time; performing an operation process based on the target data and a specified operation condition, to obtain computing data of the data simulation task, where the operation process is computing e^{iA}, the specified operation condition is that A is a square matrix, and A=−Ht, where t is a constant, and the computing data is represented in a square matrix form; decomposing the computing data into a set of finite number of quantum gates; and constructing, based on the set of the finite number of quantum gates, a quantum circuit to perform simulation, and in a case that a similarity between a circuit matrix corresponding to the quantum circuit and the computing data meets a specified condition, using simulated data obtained through simulation based on the quantum circuit as the target data.

In another implementation in this application, the operation process includes: performing eigenvalue decomposition or singular value decomposition on the square matrix A to obtain a decomposition result A′; and computing e^{iA}′ based on a Taylor's formula and an Euler's formula.

In another implementation of this application, the computing data is a computation result matrix B, and the step of decomposing the computing data into a set of finite number of quantum gates includes: converting a subscript of a non-zero element in the computation result matrix B into a binary representation form, where the computation result matrix B is a square matrix and the non-zero element in the square matrix is a complex number; expanding each item in the square matrix B and re-representing the square matrix B as a matrix B′ based on the binary representation form of the subscript of the non-zero element in the computation result matrix B; and determining, based on a value of a sub-item in each item of the matrix B′, a logical gate type corresponding to the sub-item in each item of the matrix B′.

In another implementation of this application, the constructing, based on the set of the finite number of quantum gates, a quantum circuit to perform simulation includes:

determining, based on the logical gate type corresponding to the sub-item in each item of the matrix B′, a quantum sub-circuit and a coefficient corresponding to the quantum sub-circuit, where the quantum sub-circuit corresponds to the non-zero element in the computation result matrix B; and constructing the quantum circuit based on the quantum sub-circuit and the coefficient corresponding to the quantum sub-circuit.

In another implementation of this application, the non-zero element in the computation result matrix B is Bₖⱼ, where k and j are respectively corresponding to row subscript and column subscript of the non-zero element; S is a set of non-zero elements in the computation result matrix B, s is an iteration indicator of the non-zero elements in the computation result matrix B, and a binary representation form of the subscript of the non-zero elements in the computation result matrix B is as follows:

$${k}^{s} = ( {k}_{1}^{s} , {k}_{2}^{s} , … , {k}_{m}^{s} , … , {k}_{n}^{s} )$$

$${j}^{s} = ( {j}_{1}^{s} , {j}_{2}^{s} , … , {j}_{m}^{s} , … , {j}_{n}^{s} )$$

A representation form of the computation result matrix B is as follows: B=Σₛ^{S}Bₖⱼ|k^{s}><j^{s}|.

A representation form of the matrix B′ is as follows:

$${B}^{′} = {\sum }_{s}^{S} {B}_{kj} \vert {k}_{1}^{s} 〉 〈 {j}_{1}^{s} \vert ⊗ \vert {k}_{2}^{s} 〉 〈 {j}_{2}^{s} \vert ⊗ … ⊗ \vert {k}_{m}^{s} 〉 〈 {j}_{m}^{s} \vert ⊗ … ⊗ \vert {k}_{n}^{s} 〉 〈 {j}_{n}^{s} \vert$$

where n is a number of digits obtained after a decimal row subscript or a decimal column subscript is converted into a binary digit, and m is an integer between 1 and n.

In another implementation of this application, the value of the sub-item in each item of the matrix B′ is one of |0><0|, |0><1|, |1><0|, and |1><1|.

The step of determining, based on a value of a sub-item in each item of the matrix B′, a logical gate type corresponding to the sub-item in each item of the matrix B′ includes:

determining, based on a correspondence, represented by using the following formula, between the value of the sub-item and the logical gate type, the logical gate type corresponding to the sub-item in each item of the matrix B′,

$$\vert 0 〉 〈 0 \vert = \frac{I + Z}{2}$$

$$\vert 0 〉 〈 1 \vert = \frac{X - iY}{2}$$

$$\vert 1 〉 〈 0 \vert = \frac{X + iY}{2}$$

$$\vert 1 〉 〈 1 \vert = \frac{I - Z}{2}$$

where X is a Pauli X gate, Y is a Pauli Y gate, Z is a Pauli Z gate, I is an I gate, and i is an imaginary number.

In another implementation of this application, the step of determining, based on the logical gate type corresponding to the sub-item in each item of the matrix B′, a quantum sub-circuit and a coefficient corresponding to the quantum sub-circuit includes: determining the quantum sub-circuit based on the logical gate type corresponding to the sub-item in each item in the matrix B′; and determining, based on a value of a matrix corresponding to the quantum sub-circuit and a value of a non-zero element in the matrix B′, the coefficient corresponding to the quantum sub-circuit.

In another implementation of this application, the step of determining, based on a value of a matrix corresponding to the quantum sub-circuit and a value of a non-zero element in the matrix B′, the coefficient corresponding to the quantum sub-circuit includes: executing a specified division operation, and using an operation result of the division operation as the coefficient corresponding to the quantum sub-circuit, where the specified division operation is dividing the value of the non-zero element in the matrix B′ by the value of the matrix corresponding to the quantum sub-circuit.

In another implementation of this application, the step of determining, based on the logical gate type corresponding to the sub-item in each item of the matrix B′, a quantum sub-circuit and a coefficient corresponding to the quantum sub-circuit further includes: determining that there are same quantum sub-circuits; and combining the same quantum sub-circuits, where a coefficient of a quantum sub-circuit obtained after the combination is a sum of coefficients corresponding to respective quantum sub-circuits before the combination.

In another implementation of this application, the decomposing the computing data into a set of finite number of quantum gates includes: confirming that the computing data is a unitary matrix; and in a case that the computing data is a unitary matrix, decomposing the computing data into a set of single-qubit gates and controlled NOT gates based on a Householder transformation.

In another implementation in this application, the method further includes: operating the quantum circuit based on a preset quantum operation object, where the preset quantum operation object is an operation instruction set of the quantum circuit.

In another implementation in this application, the operation instruction set of the quantum circuit includes: an instruction for acquiring a matrix corresponding to the quantum circuit; an instruction for assembling the quantum circuit into program code; an instruction for determining that a matrix corresponding to the quantum circuit is a unitary matrix; an instruction for operating the matrix corresponding to the quantum circuit; and an instruction for operating the quantum circuit.

In another implementation in this application, the steps of constructing, based on the set of the finite number of quantum gates, a quantum circuit to perform simulation, and in a case that a similarity between a circuit matrix corresponding to the quantum circuit and the computing data meets a specified condition, using simulated data obtained through simulation based on the quantum circuit as the target data includes: acquiring a process fidelity from a computation result matrix B to a circuit matrix U based on a dimension of the circuit matrix U corresponding to the quantum circuit or a dimension of the computation result matrix B, the circuit matrix U, and the computation result matrix B, where the circuit matrix U corresponding to the quantum circuit is a square matrix; computing a similarity between the circuit matrix U and the computation result matrix B based on the dimension of the circuit matrix U or the dimension of the computation result matrix B and the process fidelity from the computation result matrix B to the circuit matrix U; and in a case that the similarity between the circuit matrix U and the computation result matrix B meets a specified condition, using the simulated data obtained through simulation based on the quantum circuit as the Hamiltonian H.

In another implementation in this application, the steps of in a case that the similarity between the circuit matrix U and the computation result matrix B meets a specified condition, using the simulated data obtained through simulation based on the quantum circuit as the Hamiltonian H includes: in a case that the similarity F_{ave_fid}(B, U) between the circuit matrix U and the computation result matrix B meets the following inequality, using the simulated data obtained through simulation based on the quantum circuit as the Hamiltonian H:

$$\vert {F}_{ave \_ fid} ( B , U ) - 1 \vert < α$$

where α is a threshold, and B=e^{-iHt}.

In another implementation in this application, the step of acquiring a process fidelity from a computation result matrix B to a circuit matrix U based on a dimension of the circuit matrix U corresponding to the quantum circuit or a dimension of the computation result matrix B, the circuit matrix U, and the computation result matrix B includes: computing a matrix B1, where

$$B 1 = \sqrt{\frac{B}{dim ( B )}} ,$$

and dim(B) is a dimension of the computation result matrix B; and computing a conjugate matrix U1 of the circuit matrix U; and using a norm value of a dot product of the matrix B1 and the conjugate matrix U1 as the process fidelity from the computation result matrix B to the circuit matrix U.

In another implementation in this application, the norm value of the dot product of the matrix B1 and the conjugate matrix U1 is obtained by using the following formulas:

$$res = B 1 \cdot U 1$$

$$res\_vec = ( {res}_{1} , {res}_{2} , … , {res}_{i} , … {res}_{l} )$$

$${‖ res ‖}_{2} = \sqrt{{\sum }_{i}^{l} {res}_{i}^{2}}$$

where res is a result of a dot product of the matrix B1 and the conjugate matrix U1, res_vec is a vector obtained after res is expanded by rows, l is a square of a dimension of the computation result matrix B, and ∥res∥₂ is a norm value of the dot product of the matrix B1 and the conjugate matrix U1.

In another implementation in this application, the step of the computing a similarity between the circuit matrix U and the computation result matrix B based on the dimension of the circuit matrix U or the dimension of the computation result matrix B and the process fidelity from the computation result matrix B to the circuit matrix U includes: computing the similarity between the circuit matrix U and the computation result matrix B by using the following formulas:

$${F}_{ave \_ fid} ( B , U ) = \frac{{dF}_{state \_ fid} ( B , U ) + 1}{d + 1}$$

$${F}_{state \_ fid} ( B , U ) = {‖ res ‖}_{2}$$

where F_{ave_fid}(B, U) is a similarity between the circuit matrix U and the computation result matrix B, and F_{state_fid}(B, U) is a process fidelity between the computation result matrix B and the circuit matrix U.

In another implementation in this application, the method further includes: before acquiring the process fidelity from the computation result matrix B to the circuit matrix U, determining that the dimension of the circuit matrix U is consistent with the dimension of the computation result matrix B.

An implementation in this application provides an apparatus for processing a data simulation task, and the apparatus includes: an acquisition module, configured to obtain target data of a data simulation task, where the data simulation task is simulating Hamiltonian; and the target data is Hamiltonian H, and H is represented in a square matrix form and is independent of time; an operation module, configured to perform an operation process based on the target data and a specified operation condition, to obtain computing data of the data simulation task, where the operation process is computing e^{iA}, the specified operation condition is that A is a square matrix, and A=−Ht, where t is a constant, and the computing data is represented in a square matrix form; a decomposition module, configured to decompose the computation data into a set of finite quantum gates; and a construction module, configured to construct, based on the set of the finite number of quantum gates, a quantum circuit to perform simulation, and in a case that a similarity between a circuit matrix corresponding to the quantum circuit and the computing data meets a specified condition, use simulated data obtained through simulation based on the quantum circuit as the target data.

An implementation in this application provides an electronic device, including a memory and a processor. The memory stores a computer program. When the processor is configured to run the computer program, the method according to any one of the foregoing implementations is performed.

Another implementation in this application provides a storage medium. The storage medium stores a computer program. When the computer program is run, the method according to any one of the foregoing implementations is performed.

Compared with a related technology, in the present application, target data of a data simulation task is acquired, an operation process is performed based on the target data and a specified operation condition, to obtain computing data of the data simulation task, the computing data is decomposed into a set of finite number of quantum gates, a quantum circuit is constructed based on the set of the finite number of quantum gates to perform simulation, and in a case that a similarity between a circuit matrix corresponding to the quantum circuit and the computing data meets a specified condition, simulated data obtained through simulation based on the quantum circuit is used as the target data, so as to implement evolution simulation of Hamiltonian and solve a technical problem that it is difficult to simulate the Hamiltonian by using a classical computer.

### BRIEF DESCRIPTION OF THE DRAWINGS

To describe the technical solutions in implementations of this application or the related technologies more clearly, the accompanying drawings required for describing the implementations or the related technologies are briefly described below. Apparently, the accompanying drawings in the following description show merely some implementations of this application, and therefore should not be taken as limiting the scope. A person of ordinary skill in the art may still derive other drawings from these accompanying drawings without creative efforts.

FIG. 1 is a block diagram of a hardware structure of a computer terminal to which a method for processing a data simulation task is applied according to an implementation of this application.

FIG. 2 is a schematic diagram of a display manner of a quantum circuit according to an implementation of this application.

FIG. 3 is a schematic flowchart of a method for processing a data simulation task according to an implementation of this application.

FIG. 4 is a schematic flowchart of another method for processing a data simulation task according to an implementation of this application.

FIG. 5 is a schematic flowchart of another method for processing a data simulation task according to an implementation of this application.

FIG. 6 is a schematic structural diagram of an apparatus for processing a data simulation task according to an implementation of this application.

### DETAILED DESCRIPTION OF THE EMBODIMENTS

Embodiments described below with reference to the accompanying drawings are exemplary and merely used to explain the present application, but cannot be understood as a limitation on the present application.

An implementation of this application provides a method for processing a data simulation task. The method may be applied to an electronic device, for example, a computer terminal, specifically, a common computer, or a quantum computer, or the like.

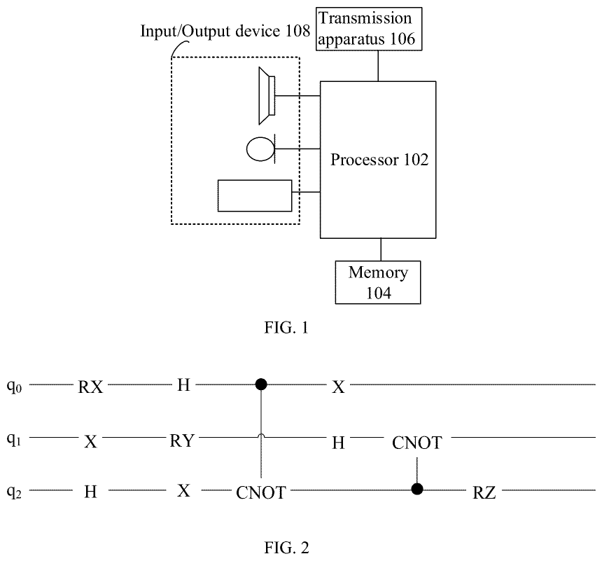

The following describes the method in detail by using an example in which the method is run on a computer terminal. FIG. 1 is a block diagram of a hardware structure of a computer terminal to which a method for processing a data simulation task is applied according to an implementation of this application. As shown in FIG. 1, the computer terminal may include one or more (only one is shown in FIG. 1) processors 102 and a memory 104 configured to store data, where the processors 102 may include, but are not limited to, a processing apparatus such as a microcontroller unit (Microcontroller Unit, MCU) or a field programmable gate array (Field Programmable Gate Array, FPGA). In some implementations, the computer terminal may further include a transmission apparatus 106 and an input/output device 108 for implementing a communications function. A person of ordinary skill in the art may understand that the structure shown in FIG. 1 is merely an example and does not constitute any limitation on a structure of the computer terminal. For example, the computer terminal may alternatively include more or fewer components than those shown in FIG. 1, or have a configuration different from that shown in FIG. 1.

The memory 104 may be configured to store a software program and a module of application software, for example, program instructions/modules corresponding to the method for processing a data simulation task in implementations of this application. By running the software program and the module stored in the memory 104, the processor 102 executes various functional applications and data processing, that is, implements the foregoing method. The memory 104 may include a high-speed random access memory, and may further include a non-volatile memory, for example, one or more disk storage apparatus, a flash memory, or another non-volatile solid-state memory. In some embodiments, the memory 104 may further include a memory remotely disposed relative to the processor 102, which may be connected to a computer terminal over a network. Examples of the network include but are not limited to the Internet, a corporate intranet, a local area network, a mobile communication network, and a combination thereof.

The transmission apparatus 106 is configured to receive or send data over a network. A specific example of the network may include a wireless network provided by a communication provider of a computer terminal. In an example, the transmit apparatus 106 includes a network interface controller (Network Interface Controller, NIC). The network interface controller may be connected to another network device through a base station to communicate with the Internet. In an example, the transmit apparatus 106 may be a radio frequency (Radio Frequency, RF) module. The radio frequency module is configured to communicate with the Internet in a wireless manner.

It should be noted that a real quantum computer is a hybrid structure that includes two main parts: One is a classical computer responsible for classical computation and control. The other is a quantum device responsible for running quantum programs to implement quantum computation. The quantum program is an instruction sequence that is written in a quantum language such as the QRunes language and that may be run on the quantum computer. In this way, quantum logic gate operations are supported, and ultimately quantum computation is implemented. Specifically, the quantum program is an instruction sequence through which quantum logic gates are operated in a specific time sequence.

In actual application, limited by the development of hardware of a quantum device, quantum computation simulation often needs to be performed to verify a quantum algorithm, quantum application, and the like. The quantum computation simulation is a process in which virtual architecture (that is, a quantum virtual machine) built by using resources of a common computer realizes simulation of running a quantum program corresponding to a specific problem. Generally, the quantum program corresponding to the specific problem needs to be constructed. The quantum program in implementations of this application is a program that is written in a classical language and that indicates qubits and their evolution. Herein, qubits, quantum logic gates, and the like related to quantum computation are all represented by corresponding classical code. The quantum circuit, as an embodiment of the quantum program, is also referred to as a quantum logic circuit and is the most commonly used general quantum computation model. The quantum circuit is a circuit that operates qubits from an abstract concept, and includes qubits, lines (timelines), and various quantum logic gates. Finally, a result usually needs to be read through a quantum measurement operation.

The quantum circuit may be presented as a quantum logic gate sequence arranged according to a specific execution time sequence, specifically, for example:

$${q}_{0} : RX ( {q}_{0} ) , H ( {q}_{0} ) , CNOT ( {q}_{0} , {q}_{2} ) , X ( {q}_{0} )$$

$${q}_{1} : X ( {q}_{1} ) , RY ( {q}_{1} ) , H ( {q}_{1} ) , CNOT ( {q}_{2} , {q}_{1} )$$

$${q}_{2} : H ( {q}_{2} ) , X ( {q}_{2} ) , CNOT ( {q}_{0} , {q}_{2} ) , CNOT ( {q}_{2} , {q}_{1} ) , RZ ( {q}_{2} )$$

A more vivid presentation manner of the quantum circuit corresponding to the foregoing quantum logic gate sequence is shown in FIG. 2.

A conventional circuit is connected through metallic wires to transmit voltage signals or current signals. Different from the conventional circuit, the quantum circuit may be considered to be connected by time. To be specific, a state of a qubit evolves naturally with time. This process proceeds according to an instruction of the Hamiltonian operator until the qubit is operated by a logic gate.

One quantum program as a whole corresponds to one total quantum circuit. The quantum program in this application indicates the total quantum circuit. A total quantity of qubits in the total quantum circuit is the same as a total quantity of qubits in the quantum program. It may be understood that one quantum program may include a quantum circuit, a measurement operation for qubits in the quantum circuit, a register for saving a measurement result, and a control flow node (a jump instruction), and one quantum circuit may include tens of or hundreds of or even thousands of quantum logic gate operations. An execution process of the quantum program is a process of executing all quantum logic gates in a specific time sequence. It should be noted that the time sequence is a sequence of time at which an individual quantum logic gate is executed.

It should be noted that in classical computation, the most basic unit is a bit, and the most basic control mode is a logic gate. A purpose of controlling a circuit may be achieved through a combination of logic gates. Similarly, a manner of processing the qubit is to use the quantum logic gate. The use of the quantum logic gate enables the evolution of a quantum state. The quantum logic gate is a base for forming the quantum circuit. The quantum logic gate includes single-bit quantum logic gates such as the Hadamard gate (H gate, Hadamard gate), the Pauli-X gate (X gate), the Pauli-Y gate (Y gate), the Pauli-Z gate (Z gate), the RX gate, the RY gate, and the RZ gate; and multi-bit quantum logic gates such as the CNOT gate, the CR gate, the iSWAP gate, or the Toffoli gate. The quantum logic gate is generally represented by using a unitary matrix. The unitary matrix is not only a matrix form but also an operation and a transform. Generally, an action of the quantum logic gate on a quantum state is calculated by left multiplying a unitary matrix by a matrix corresponding to a quantum state ket.

A person skilled in the art may understand that, in a classic computer, a basic unit of information is a bit, and one bit has two states, namely, 0 and 1. The most common physical implementation is to express the two states by low level and high level respectively. In quantum computation, a basic unit of information is a qubit, and one qubit also has two states of 0 and 1, which are recorded as |0> and |1>. However, the qubit may be in a superposition state of the two states of 0 and 1, which may be expressed as |φ>=a|0>+b|1>, where a and b are complex numbers expressing an amplitude (a probability amplitude) of the state |0> and the state |1>, which is not contained in a bit in the classic computer. After measurement, the states of the qubit collapses to a specific state (eigenstate, namely state |0> and state |1> herein), where a probability of collapsing to state |0> is |a|², a probability of collapsing to state |1> is |b|², |a|²+|b|²=1, and |> is a Dirac notation.

A quantum state refers to a state of a qubit, and an eigenstate thereof is represented by using a binary in a quantum algorithm (or referred to as a quantum program). For example, a set of qubits are q0, q1, and q2, representing qubits in the order of the 0^{th} bit, the 1^{st} bit, and the 2^{nd} bit, and the qubits are ordered from a high bit to a low bit as q2q1q0. Quantum states of the set of qubits is a superposition state of 23 eigenstates, and 8 eigenstates (determined states) are: |000>, |001>, |010>, |011>, |100>, |101>, 110>, and |111>. Each eigenstate corresponds to a qubit position, for example, for the state |000>, 000 corresponds to q2q1q0 from high order to low order. In short, a quantum state is a superposition state composed of eigenstates. When probability amplitudes of other states are 0, the quantum state is in one of the determined eigenstates.

The following further describes a method for processing a data simulation task provided in an implementation of this application.

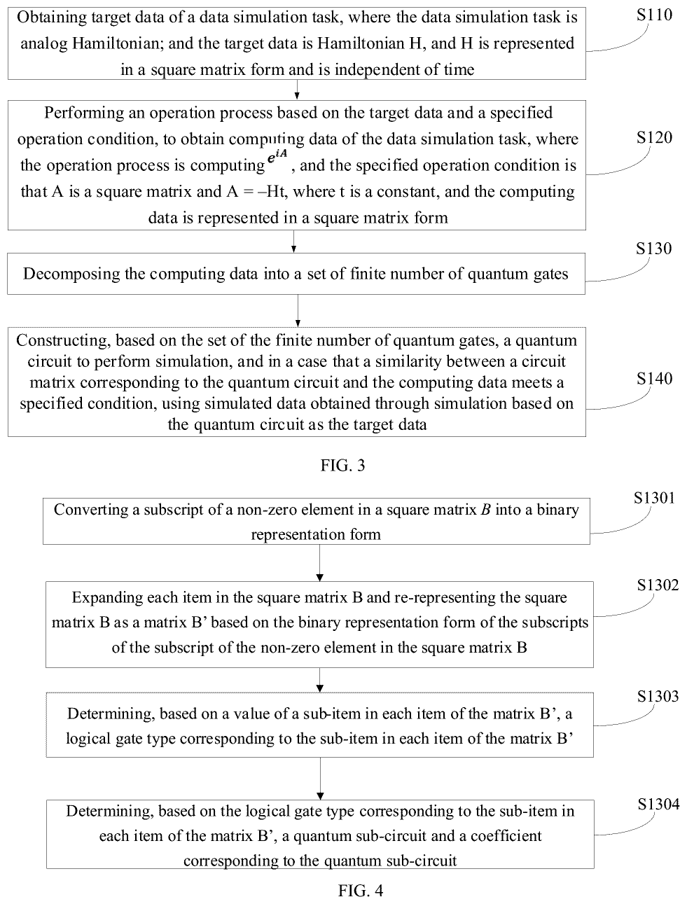

Referring to FIG. 3, FIG. 3 is a schematic flowchart of a method for processing a data simulation task according to an implementation of this application, and the method includes Step S110 to Step S140.

S110: Obtaining target data of a data simulation task, where the data simulation task is simulating Hamiltonian; and the target data is Hamiltonian H, and H is represented in a square matrix form and is independent of time.

Simulating properties of a quantum system is one of the important applications of a quantum computer. Generally, to analyze the properties of a quantum system, Hamiltonian of the quantum system needs to be written first. For physical systems at different scales, the Hamiltonians often have different forms. Quantum chemistry is used as an example. A property of a molecule is mainly determined by a Coulomb interaction between electrons. Therefore, each term in Hamiltonian of the molecule is written by a Fermion operator acting on an electron wave function. A basic component unit, qubit, and commonly used Pauli operator are corresponding to spin and spin operator in physics.

A Heisenberg model is used as an example. The Heisenberg model is a very important model in study of quantum magnetism and quantum many-body physics. To-be-simulated Hamiltonian H of the Heisenberg model may be written as the following formula:

$$H = {\sum }_{〈 i , j 〉} ( {J}_{x} {S}_{i}^{x} {S}_{j}^{x} + {J}_{y} {S}_{i}^{y} {S}_{j}^{y} + {J}_{z} {S}_{i}^{z} {S}_{j}^{z} ) + {\sum }_{i} {h}_{Z} {S}_{i}^{z}$$

where <i,j> depends on a specific grid geometric structure, Jₓ, J_{y}, and J_{z} are spin coupling strengths in the three directions of x, y, and z, respectively, and h_{z} is an external magnetic field in the direction z. If J_{z}=0 is taken, the formula of the to-be-simulated Hamiltonian H of the Heisenberg model may also be used to describe Hamiltonian of an XY model; if Jₓ=J_{y}=0 is taken, the formula of the to-be-simulated Hamiltonian H of the Heisenberg model may be used to describe Hamiltonian of an Ising model. It should be noted that multi-body spin operators Sᵢ^{x}, Sᵢ^{y}, and Sᵢ^{a} commonly used in quantum multi-body physics are used herein, which are operators that act on a multi-body wave function. For a spin-1/2 system, a many-body spin operator may be simply written in a tensor product form of a Pauli operator (omitting a coefficient h/2):

$${S}_{i}^{P} = ( {⊗}_{j = 0}^{i - 1} I ) ⊗ σ P ⊗ ( {⊗}_{j = i + 1}^{L} I ) ,$$

$$P ∈ \{ x , y , z \}$$

where σ and P are Pauli operators, and may also be represented by using XYZ operators.

After the formula of a quantum system is obtained, a matrix representation form of Hamiltonian H may be obtained by setting a parameter in the formula. In a case in which the matrix representation form is a square matrix representation form, the matrix representation form may be used as the target data in this implementation. For example, an order of the Hamiltonian H is N=2ⁿ, where n is a quantity of qubits included in a to-be-encoded quantum circuit.

$$H = [ \begin{matrix}{a}_{11} + {b}_{11} i & {a}_{12} + {b}_{12} i & … & {a}_{1 N} + {b}_{1 N} i \\ {a}_{21} + {b}_{21} i & {a}_{22} + {b}_{22} i & … & {a}_{2 N} + {b}_{2 N} i \\ … & … & … & … \\ {a}_{N 1} + {b}_{N 1} i & {a}_{N 2} + {b}_{N 2} i & … & {a}_{NN} + {b}_{NN} i\end{matrix} ]$$

Each element of the Hamiltonian H is in a complex form, that is, each element includes a real part and an imaginary part.

After the target data of the data simulation task is acquired, Step S120 is performed.

S120: Performing an operation process based on the target data and a specified operation condition, to obtain computing data of the data simulation task, where the operation process is computing e^{iA}, the specified operation condition is that A is a square matrix, and A=−Ht, where t is a constant, and the computing data is represented in a square matrix form.

Because the Hamiltonian H and time are independent of each other, t may be a constant, for example, t=1 may be set. The Hamiltonian H is simulated on an exponential basis, so that different Hamiltonian may be operated on a physical system, and time evolution from an initial state to a final state may be implemented.

There are many methods for computing e^{-iHt}, which use different simulation approximation algorithms. In addition, t is generally 1 by default. For example, the Taylor formula and the Euler formula may be used for approximate computing e^{iA}, or the Pade approximation may be used for computing e^{iA}. The following uses the Taylor formula and the Euler formula as examples to specifically describe the method for computing e^{iA}.

$${e}^{iA} = cos A + i sin A$$

$$cos A = 1 - \frac{{A}^{2}}{2 !} + \frac{{A}^{4}}{4 !} + … + {( - 1 )}^{n} \frac{{A}^{2 n}}{( 2 n ) !} …$$

$$sin A = A - \frac{{A}^{3}}{3 !} + \frac{{A}^{5}}{5 !} + … + {( - 1 )}^{n} \frac{{A}^{2 n + 1}}{( 2 n + 1 ) !} …$$

To reduce a computing amount, in this implementation, a decomposition operation is performed on A in advance. Because A is a square matrix, singular value decomposition or eigenvalue decomposition is performed on the square matrix A, where a decomposition result is A′. The singular value decomposition is used as an example for description.

Singular value decomposition is an important matrix decomposition in linear algebra, and has important applications in fields of signal processing, statistics, and the like. Singular value decomposition is performed on a square matrix A_{n×n}, which may be expressed as three matrices that are multiplied as follows:

$${A}_{n \times n} = {U}_{n \times r} {\sum }_{r \times n} {V}_{n \times n}^{*}$$

where U is an n×n order unitary matrix, which is also referred to as a left singular vector matrix; Σ is an r×n order diagonal matrix with non-negative real numbers; and V*, as conjugate transposition of V, is an n×n order unitary matrix, which is also referred to as a right singular vector matrix. Such decomposition is referred to as singular value decomposition of A, and elements on diagonal of Σ are singular values of A.

After the singular value decomposition is performed on the square matrix A, an exponentiation computing operation is performed, and exponentiation computing needs to be performed on a decomposed diagonal matrix Σ, that is, exponentiation computing is performed on main diagonal elements in the diagonal matrix Σ. This greatly simplifies a computing amount, and reduces time complexity and space complexity.

A computation result of e^{iA} is also a square matrix representation form, and after the computing data of the data simulation task is obtained, Step S130 is performed.

S130: Decomposing the computing data into a set of finite number of quantum gates.

As shown in FIG. 4, in some implementations, the decomposing the computing data into a set of finite number of quantum gates may include the following steps.

S1301: Converting a subscript of a non-zero element in a square matrix B into a binary representation form. The computing data of the data simulation task may be a computation result matrix B of e^{iA}, where B is a square matrix, and a non-zero element in the square matrix B is Bₖⱼ, k and j are respectively corresponding to row subscript and column subscript of Bₖⱼ. In this case, the square matrix B may be represented as B=Σₛ^{S}Bₖⱼ|k^{s}><j^{s}|. S is a set of non-zero elements in the square matrix B, which may also be understood as a quantity of terms of a linear combination obtained before coefficients are combined, and s is an iteration index of a non-zero element in the square matrix B, which may also be understood as a sequence number of the non-zero element.

Subscripts of the non-zero element Bₖⱼ in the square matrix B may be converted into the following binary representation form:

$${k}^{s} = ( {k}_{1}^{s} , {k}_{2}^{s} , … , {k}_{m}^{s} , … , {k}_{n}^{s} )$$

$${j}^{s} = ( {j}_{1}^{s} , {j}_{2}^{s} , … , {j}_{m}^{s} , … , {j}_{n}^{s} )$$

where n is a number of digits obtained after a decimal row subscript or a decimal column subscript is converted into a binary digit, and m is an integer between 1 and n.

S1302: Expanding each item in the square matrix B and re-representing the square matrix B as a matrix B′ based on the binary representation form of the subscripts of the subscript of the non-zero element in the square matrix B. Each item in the square matrix B is each item in the non-zero element set in the square matrix B.

After each item in the square matrix B is expanded, a representation form of the matrix B′ that is re-represented is as follows:

$${B}^{′} = {\sum }_{s}^{S} {B}_{kj} \vert {k}_{1}^{s} 〉 〈 {j}_{1}^{s} \vert ⊗ \vert {k}_{2}^{s} 〉 〈 {j}_{2}^{s} \vert ⊗ … ⊗ \vert {k}_{m}^{s} 〉 〈 {j}_{m}^{s} \vert ⊗ … ⊗ \vert {k}_{n}^{s} 〉 〈 {j}_{n}^{s} \vert$$

S1303: Determining, based on a value of a sub-item in each item of the matrix B′, a logical gate type corresponding to the sub-item in each item of the matrix B′.

According to the representation form of the matrix B′, a value of kₘ^{s} may be only 0 or 1, and a value of jₘ^{s} may be only 0 or 1. In other words, a value of a sub-item |kₘ^{s}><jₘ^{s}| in each item of the matrix B′ may be only one of |0><0|, |0><1|, |1><0|, and |1><1|.

Based on a value status of a sub-item in each item in the matrix B′, each value may be defined to correspond to a logical gate type formed by a combination of a Pauli gate and an I gate (a second-order unit matrix). The correspondence is as follows:

$$\vert 0 〉 〈 0 \vert = \frac{I + Z}{2}$$

$$\vert 0 〉 〈 1 \vert = \frac{X - iY}{2}$$

$$\vert 1 〉 〈 0 \vert = \frac{X + iY}{2}$$

$$\vert 1 〉 〈 1 \vert = \frac{I - Z}{2}$$

where i denotes an imaginary number.

S1304: Determining, based on the logical gate type corresponding to the sub-item in each item of the matrix B′, a quantum sub-circuit and a coefficient corresponding to the quantum sub-circuit.

The quantum circuit corresponds to a non-zero element.

Specifically, Step S1304 may include the following steps.

S13041: Determining the quantum sub-circuit based on the logical gate type corresponding to the sub-item in each item in the matrix B′.

A finite number of qubits that need to be acted on by a quantum logic gate are defined. According to the logic gate type corresponding to the sub-item in each item in the matrix B′, logic gates in the logic gate type act on the qubits according to a time sequence to construct a quantum circuit.

A representation form of the matrix B″ corresponding to the constructed quantum circuit is as follows:

$${B}^{″} = {\sum }_{s}^{S} {B}_{k , j} {\sum }_{l}^{L} {ω}_{l}^{s}$$

where L is a set of Pauli operator sub-circuits, l is an iteration index of a Pauli operator sub-circuit, and ω denotes a sub-circuit.

S13042: Determining, based on a value of a matrix corresponding to the quantum sub-circuit and a value of the non-zero element, the coefficient corresponding to the quantum sub-circuit.

The coefficient corresponding to the quantum sub-circuit may be determined by dividing the value of the non-zero element by the value of the matrix corresponding to the quantum sub-circuit. In this way, the quantum sub-circuit and the coefficient corresponding to the non-zero element may be obtained.

Basic properties of a set include independence, mutuality, and disorder, that is, for all elements in the set, there are no two identical elements. Therefore, optionally, Step S1304 may further include the following steps.

S13043: Determining whether there are identical quantum sub-circuits.

In other words, after Step S13042 is completed, whether identical quantum sub-circuits exist needs to be determined. If there are identical quantum sub-circuits, Step S13044 is performed. If identical quantum sub-circuits do not exist, Step S140 is performed.

S13044: Combining the identical quantum sub-circuits into one item.

A coefficient of a quantum sub-circuit obtained after the combination is a sum of coefficients corresponding to respective quantum sub-circuits before the combination.

After the quantum sub-circuit and the coefficient corresponding to the quantum sub-circuit are determined, Step S140 may be performed to construct a quantum circuit to perform simulation. In this case, respective quantum sub-circuits may be connected according to a time sequence after the coefficient is encoded into the quantum sub-circuits, so as to form a complete quantum circuit.

Compared with a related technology, based on the method for decomposing the computing data into a set of finite number of quantum gates shown in FIG. 4, a subscript of a non-zero element in a matrix is converted into a binary representation form, and a quantum sub-circuit and a coefficient corresponding to the quantum sub-circuit are determined based on the logical gate type corresponding to the sub-item in each item of the matrix, which provides a basis for subsequent construction of a quantum circuit. This method only requires that the matrix be a square matrix, and does not have other requirements such as the matrix being a density matrix or a Hermitian matrix. Therefore, Pauli operator decomposition of a complex matrix of any matrix type is implemented, and a technical problem in the related technology that it is difficult to encode the matrix into a corresponding quantum circuit is solved.

In some implementations, before Step S130 is performed, the following determining may be performed: determining whether a computation result of e^{iA} is a unitary matrix. If it is not a unitary matrix, the computation result of e^{iA} is directly decomposed into a linear combination of a finite number of Pauli gates. If it is a unitary matrix, the computation result of e^{iA} is decomposed into a set of single-qubit gates and controlled NOT gates based on a Householder transformation. The decomposition process is as follows.

It is assumed that the computation result of e i is a unitary matrix B, an order of B is N=2ⁿ, and n is a quantity of qubits included in a to-be-encoded quantum circuit. A diagonal matrix R and (N−1) Householder matrices are determined based on the Householder transformation to make the unitary matrix B=H₁H₂ . . . Hⱼ . . . H_{N-1}R, where Hⱼ is a Householder matrix corresponded when the j^{th} Householder transformation is performed on the unitary matrix B, and 1≤j≤N−1; the diagonal matrix R is split into 2ⁿ−1 unitary matrixes corresponding to single quantum logic gates carrying controlled information, and U₀U₁ . . . Uₘ . . . U₂_{ⁿ⁻¹}₋₁=R is satisfied, where Uₘ is a unitary matrix corresponding to the (m+1)^{th} single quantum logic gate carrying controlled information, and 0≤m≤2ⁿ⁻¹−1; and a sequence including 2ⁿ⁻¹ single quantum logic gates carrying controlled information is determined as the quantum sub-circuit Cir_{R}. In this case, Step S140 may be performed to construct a quantum circuit based on the set of the finite quantum gates. In other words, quantum sub-circuits Cir_{R}, Cir_{N-1}, . . . , Cirⱼ, Cir₁ are successively connected based on the unitary matrixes corresponding to the single quantum logic gates carrying the controlled information and the sequence of the single quantum logic gates carrying the controlled information, and a quantum circuit corresponding to the unitary matrix B is generated.

S140: Constructing, based on the set of the finite number of quantum gates, a quantum circuit to perform simulation, and in a case that a similarity between a circuit matrix corresponding to the quantum circuit and the computing data meets a specified condition, using simulated data obtained through simulation based on the quantum circuit as the target data.

A finite number of qubits that need to be acted on by a quantum logic gate are defined, and quantum gates in the set act on the qubits according to a time sequence to construct the quantum circuit.

After the quantum circuit is constructed, simulation may be performed by operating the quantum circuit.

The method for processing a data simulation task provided in the implementation of this application may further include the following steps.

S150: Operating the constructed quantum circuit based on a preset quantum operation object, where the operation object is an operation instruction set of the quantum circuit.

The operation instruction set of the quantum circuit includes: an instruction for acquiring a matrix corresponding to the constructed quantum circuit; an instruction for assembling the quantum circuit into program code; an instruction for determining whether a matrix corresponding to the quantum circuit is a unitary matrix; an instruction for operating the matrix corresponding to the quantum circuit; and an instruction for operating the quantum circuit.

The program code may be OriginIR from the Origin Quantum Computing Technology Co., LTD, or may be OpenQASM from the IBM company or a program corresponding to another quantum application software. The instructions for operating the quantum circuit may include instructions such as inserting a logic gate, applying a transposition conjugate and a controlled operation, adding control bits, and measuring.

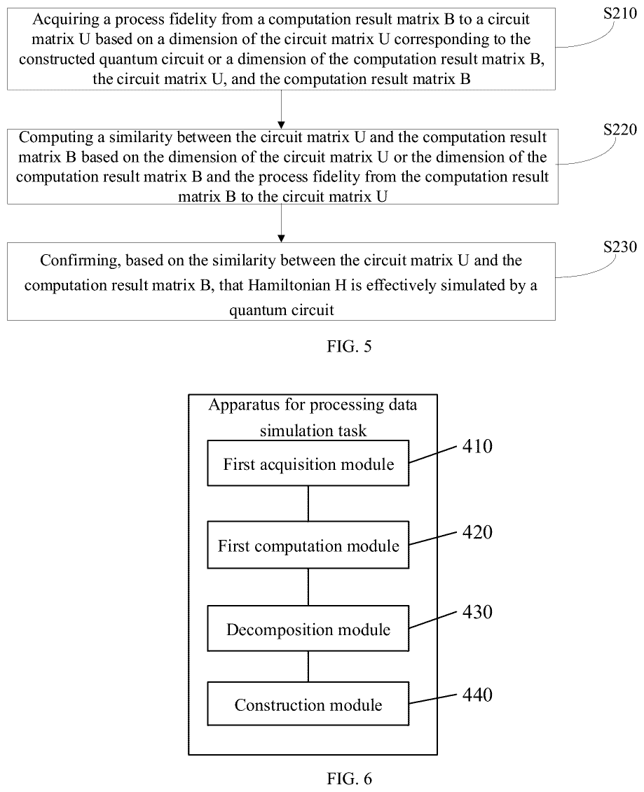

As shown in FIG. 5, in some implementations, after the computing data of the data simulation task is obtained, whether Hamiltonian is effectively simulated by a quantum circuit may be measured by computing matrix similarity.

A method for computing matrix similarity to measure whether Hamiltonian is effectively simulated by the quantum circuit may include the following steps.

S210: Acquiring a process fidelity from a computation result matrix B to a circuit matrix U based on a dimension of the circuit matrix U corresponding to the constructed quantum circuit or a dimension of the computation result matrix B, the circuit matrix U, and the computation result matrix B.

After the circuit matrix U corresponding to the constructed quantum circuit and the computation result matrix B are acquired, it may be first determined whether both the circuit matrix U and the computation result matrix B are square matrices and have a same dimension.

A square matrix is that a quantity of rows and a quantity of columns of the matrix are the same, and a dimension of the square matrix is a quantity of rows or a quantity of columns. Whether the circuit matrix U or the computation result matrix B is a square matrix can be determined depending on whether a quantity of rows and a quantity of columns of the circuit matrix U are the same or a quantity of rows and a quantity of columns of the computation result matrix B are the same. If the quantity of rows and quantity of columns of the circuit matrix U are the same and a quantity of rows and a quantity of columns of the computation result matrix B are the same, it is determined that both the circuit matrix U and the computation result matrix B are square matrices. Then, it is determined whether the quantity of rows or columns of the circuit matrix U is the same as the quantity of rows or columns of the computation result matrix B. If the quantity of rows or columns of the circuit matrix U is the same as the quantity of rows or columns of the computation result matrix B, it is determined that dimensions of the circuit matrix U and the computation result matrix B are consistent, and S2101 continues to be performed.

In S210, the process fidelity is a fidelity metric value of two matrices, and is used to measure a fidelity relationship between the two matrices.

The acquiring a process fidelity from a computation result matrix B to a circuit matrix U based on the dimension of the circuit matrix U or the dimension of the computation result matrix B, the circuit matrix U, and the computation result matrix B may include the following steps.

S2101: Computing B1.

$$B 1 = \sqrt{\frac{B}{dim ( B )}} ;$$

and dim(B) is a dimension of the computation result matrix B.

S2102: Computing a conjugate matrix U1 of the circuit matrix U.
That is,

$$U 1 = \overline{U} .$$

S2103: Acquiring a norm value of a dot product of B1 and the conjugate matrix U1, where the norm value is the process fidelity from the computation result matrix B to the circuit matrix U. A result of a dot product of B1 and the conjugate matrix U1 is res, namely, res=B1 U1.

In other words, a vector obtained after the res expands according to a row is as follows:

$$res\_vec = ( {res}_{1} , {res}_{2} , … , {res}_{i} , … {res}_{n} )$$

where n is a square of a dimension of the computation result matrix B.

The norm value is obtained by using the following formula:

$${‖ res ‖}_{2} = \sqrt{{\sum }_{i}^{n} {res}_{i}^{2}}$$

where ∥res∥₂ is the norm value, namely, the process fidelity from the computation result matrix B to the circuit matrix U.

After the process fidelity from the computation result matrix B to the circuit matrix U is acquired, Step S220 is performed.

S220: Computing a similarity between the circuit matrix U and the computation result matrix B based on the dimension of the circuit matrix U or the dimension of the computation result matrix B and the process fidelity from the computation result matrix B to the circuit matrix U.

The similarity between the circuit matrix U and the computation result matrix B is obtained by using the following formula:

$${F}_{ave \_ fid} ( B , U ) = \frac{{dF}_{state \_ fid} ( B , U ) + 1}{d + 1}$$

$${F}_{state \_ fid} ( B , U ) = {‖ res ‖}_{2}$$

where F_{ave_fid}(B, U) is the similarity between the circuit matrix U and the computation result matrix B, and F_{state_fid}(B, U) is the process fidelity from the computation result matrix B to the circuit matrix U.

After the similarity between the circuit matrix U and the computation result matrix B is obtained, Step S230 may be performed.

S230: Confirming, based on the similarity between the circuit matrix U and the computation result matrix B, that Hamiltonian H is effectively simulated by a quantum circuit.

Specifically, the confirming, based on the similarity between the circuit matrix U and the computation result matrix B, that to-be-simulated Hamiltonian H is effectively simulated by a quantum circuit includes:

determining whether the similarity F_{ave_fid}(B, U) between the circuit matrix U and the computation result matrix B satisfies the following inequality:

$$\vert {F}_{ave \_ fid} ( B , U ) - 1 \vert < α$$

where α is a threshold, and may be manually set.

If the foregoing inequality is satisfied, it may be considered that the similarity F_{ave_fid}(B, U) between the circuit matrix U and the computation result matrix B is close to 1, it is confirmed that the to-be-simulated Hamiltonian H can be effectively simulated by a quantum circuit. If the foregoing inequality is not satisfied, the to-be-simulated Hamiltonian H cannot be effectively simulated by a quantum circuit.

Compared with a conventional technology, based on the method for processing a data simulation task shown in FIG. 5, a degree of simulation of computing data may be determined after the computing data of the data simulation task is obtained, so as to improve a processing level of the data simulation task.

Referring to FIG. 6, FIG. 6 is a schematic structural diagram of an apparatus for processing a data simulation task according to an implementation of this application.

Corresponding to the process shown in FIG. 3, the apparatus may include:
an acquisition module 410, configured to obtain target data of a data simulation task, where the data simulation task is simulating Hamiltonian; and the target data is Hamiltonian H, and H is represented in a square matrix form and is independent of time;
a first computation module 420, configured to perform an operation process based on the target data and a specified operation condition, to obtain computing data of the data simulation task, where the operation process is computing e^{iA}, the specified operation condition is that A is a square matrix, and A=−Ht, where t is a constant, and the computing data is represented in a square matrix form;
a decomposition module 430, configured to decompose the computation data into a set of finite quantum gates; and
a construction module 440, configured to: construct, based on the set of the finite number of quantum gates, a quantum circuit to perform simulation, and in a case that a similarity between a circuit matrix corresponding to the quantum circuit and the computing data meets a specified condition, use simulated data obtained through simulation based on the quantum circuit as the target data.

In some implementations, the computation module 420 may include:
a first decomposition unit, configured to perform eigenvalue decomposition or singular value decomposition on the square matrix A to obtain a decomposition result A′; and
a computation unit, configured to computing e^{iA}′ based on a Taylor's formula and an Euler's formula.

In some implementations, the computation result is a computation result matrix B. The decomposition module 430 includes:
a conversion unit, configured to convert a subscript of a non-zero element in the computation result matrix B into a binary representation form;
a second decomposition unit, configured to expand each item in the square matrix B and re-represent the square matrix B as a matrix B′ based on the binary representation form of the subscript of the non-zero element in the computation result matrix B;
a first determining unit, configured to determine, based on a value of a sub-item in each item of the matrix B′, a logical gate type corresponding to the sub-item in each item of the matrix; and
a second determining unit, configured to determine, based on the logical gate type corresponding to the sub-item in each item of the matrix B′, a quantum sub-circuit and a coefficient corresponding to the quantum sub-circuit, where the quantum sub-circuit corresponds to the non-zero element.

In some implementations, the decomposition module 430 may further include:
a confirmation unit, configured to confirm whether the computation result is a unitary matrix; and
a third decomposition unit, configured to: decompose, in a case that the computing data is a unitary matrix, the computing data into a set of single-qubit gates and controlled NOT gates based on a Householder transformation.
In some implementations, the apparatus for processing a data simulation task further includes:
an operation module, configured to operate the constructed quantum circuit based on a preset quantum operation object, where the operation object is an operation instruction set of the quantum circuit.

In some implementations, the operation instruction set of the quantum circuit includes:
an instruction for acquiring a matrix corresponding to the constructed quantum circuit; an instruction for assembling the quantum circuit into program code; an instruction for determining whether a matrix corresponding to the quantum circuit is a unitary matrix; an instruction for operating the matrix corresponding to the quantum circuit; and an instruction for operating the quantum circuit.

Optionally, a simulation apparatus 400 of Hamiltonian further includes:
a second acquisition module, configured to acquire, based on a dimension of a circuit matrix corresponding to the constructed quantum circuit or a dimension of a computation result matrix corresponding to the computation result, the circuit matrix, and the computation result matrix, a process fidelity from the computation result matrix to the circuit matrix;
a second computation module, configured to compute a similarity between the circuit matrix and the computation result matrix based on the dimension of the circuit matrix or the dimension of the computation result matrix and the process fidelity from the computation result matrix to the circuit matrix; and
a confirmation module, configured to confirm, based on the similarity between the circuit matrix and the computation result matrix, that the Hamiltonian is effectively simulated by the quantum circuit.

An implementation of this application further provides an electronic device, including a memory and a processor. The memory stores a computer program. The processor is configured to run the computer program, so that the steps in any one of the implementations are performed.

Specifically, the electronic device may further include a transmit device and an input/output device. The transmit device is connected to the processor. The input/output device is connected to the processor.

In some implementations, there may be one or more processors in the electronic device.

The processor may be implemented by hardware or software. When implemented by using hardware, the processor may be a logic circuit, an integrated circuit, or the like. When implemented by using software, the processor may be a general-purpose processor, and is implemented by reading software code stored in the memory.

In some implementations, there may be one or more memories in the electronic device.

The memory may be integrated with the processor, or may be disposed separately from the processor. This is not limited in the present application. For example, the memory may be a non-transitory processor, for example, a read-only memory ROM, which may be integrated on a same chip as the processor, or may be separately disposed on different chips. A type of the memory and a setting manner of the memory and the processor are not specifically limited in the present application.

For example, the electronic device may be a field programmable gate array (Field Programmable Gate Array, FPGA), an application specific integrated circuit (Application Specific Integrated Circuit, ASIC), a system on chip (System On Chip, SoC), a central processor unit (Central Processor Unit, CPU), a network processor (Network Processor, NP), a digital signal processor (Digital Signal Processor, DSP), a micro controller unit (Micro Controller Unit, MCU), a programmable logic device (Programmable Logic Device, PLD), or another integrated chip.

It should be understood that the processor in implementations of this application may be a central processing unit (Central Processing Unit, CPU), or may be another general-purpose processor, a digital signal processor (Digital Signal Processor, DSP), an application specific integrated circuit (Application Specific Integrated Circuit, ASIC), a field programmable gate array (Field Programmable Gate Array, FPGA) or another programmable logic device, a discrete gate or transistor logic device, a discrete hardware component, or the like. The general-purpose processor may be a microprocessor, or the processor may be any conventional processor or the like.

It should be understood that the memory in embodiments of the present application may be a volatile memory or a nonvolatile memory, or may include both a volatile memory and a nonvolatile memory. The non-volatile memory may be a read-only memory (read-only memory, ROM), a programmable read-only memory (Programmable ROM, PROM), an erasable programmable read-only memory (erasable PROM, EPROM), an electrically erasable programmable read-only memory (Electrically EPROM, EEPROM), or a flash memory. The volatile memory may be a random access memory (random access memory, RAM) that serves as an external cache. By way of example but not limitative description, many forms of random access memories (random access memory, RAM) may be used, for example, a static random access memory (static RAM, SRAM), a dynamic random access memory (DRAM), a synchronous dynamic random access memory (Synchronous DRAM, SDRAM), a double data rate synchronous dynamic random access memory (double data rate SDRAM, DDR SDRAM), an enhanced synchronous dynamic random access memory (enhanced SDRAM, ESDRAM), a synchlink dynamic random access memory (Synchlink DRAM, SLDRAM), and a direct rambus random access memory (direct rambus RAM, DR RAM).

An implementation of this application further provides a quantum computer operating system, and the quantum computer operating system implements simulation of Hamiltonian according to any one of the foregoing method embodiments provided in the embodiments of the present application.

An implementation of this application further provides a quantum computer, where the quantum computer includes the foregoing quantum computer operating system.

An implementation of this application further provides a storage medium, where the storage medium stores a computer program. When the computer program is run, the steps in any one of the foregoing implementations are performed.

Specifically, in this implementation, the storage medium may include but is not limited to any medium that may store a computer program, for example, a USB flash drive, a read-only memory (Read-Only Memory, ROM), a random access memory (Random Access memory, RAM), a removable hard disk, a magnetic disk, or an optical disc.

All or some of the foregoing implementations may be implemented by means of software, hardware (such as circuit), firmware, or any combination thereof. When software is used to implement embodiments, the foregoing embodiments may be implemented completely or partially in a form of a computer program product. The computer program product includes one or more computer instructions or computer programs. When the computer instructions or computer programs are loaded and executed on a computer, the procedures or functions according to the embodiments of the present application are completely or partially generated. The computer may be a general-purpose computer, a dedicated computer, a computer network, or another programmable apparatus. The computer instructions may be stored in a computer-readable storage medium or transmitted from one computer-readable storage medium to another computer-readable storage medium. For example, the computer instructions may be transmitted from a website, computer, server, or data center to another website, computer, server, or data center via a wireless (such as infrared, radio, and microwave) manner. The computer-readable storage medium may be any available medium accessible by a computer or a data storage device such as a server or a data center that includes one or more available media integrations. The available medium may be a magnetic medium (for example, a floppy disk, a hard disk, or a magnetic tape), an optical medium (for example, a DVD), or a semiconductor medium. The semiconductor medium may be a solid-state disk.

It should be understood that, the term “and/or” in this application merely describes an association relationship for describing associated objects and represents that three relationships may exist. For example, A and/or B may represent the following three cases: Only A exists, both A and B exist, and only B exists, where A and B may be singular or plural. In addition, the character “/” in this application generally represents an “or” relationship between the associated objects, and may represent an “and/or” relationship, which may be understood with reference to the context.

In the present application, “at least one” means one or more, and “a plurality of” means at least two. “At least one of the following” or a similar expression thereof indicates any combination of the following, and includes any combination of one or more of the following. For example, at least one of a, b, or c may indicate: a, b, c, a-b, a-c, b-c, or a-b-c, where a, b, and c may be singular or plural.

It should be understood that, in the embodiments of the present application, sequence numbers of the foregoing processes do not mean execution sequences. The execution sequences of the processes should be determined according to functions and internal logic of the processes, and should not be construed as any limitation on the implementation processes of the embodiments of the present application.

Persons of ordinary skill in the art may be aware that, units and algorithm steps in examples described in combination with the embodiments disclosed in this application can be implemented by electronic hardware or a combination of computer software and electronic hardware. Whether the functions are performed by hardware or software depends on particular applications and design constraints of the technical solutions. A person skilled in the art may use different methods to implement the described functions for each specific application, but it should not be considered that the implementation goes beyond the scope of the present application.

Those skilled in the art that may clearly understand that, for the purpose of convenient and brief description, for detailed working processes of the foregoing system, apparatus, and unit, reference may be made to the corresponding processes in the foregoing method embodiments, and details are not described herein again.

In several embodiments provided in the present application, it should be understood that, the disclosed system, apparatus, and method may be implemented in other manners. For example, the described apparatus embodiments are merely examples. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented by using some interfaces.

The indirect couplings or communication connections between the apparatus or units may be implemented in electronic, mechanical, or other forms.

The units described as separate components may be or may not be physically separated, and the components displayed as units may be or may not be physical units, that is, may be located in one place or distributed on a plurality of network units. Some or all of the units may be selected according to actual needs to achieve the objective of the solutions of the embodiments.

In addition, function units in the embodiments of the present application may be integrated into one processing unit, or each of the units may exist alone physically, or two or more units may be integrated into one unit.

When the functions are implemented in a form of a software function unit and sold or used as an independent product, the functions may be stored in a computer-readable storage medium. Based on such an understanding, the technical solutions of the present application essentially, or the part contributing to the conventional technology, or some of the technical solutions may be implemented in the form of a software product. The computer software product is stored in a storage medium and includes several instructions for instructing a computer device (which may be a personal computer, a server, a network device, or the like) to perform all or some of the steps of the methods described in the embodiments of the present application.

The foregoing descriptions are merely specific implementations of the present application, but the protection scope of the present application is not limited thereto. Any variation or replacement readily figured out by a person skilled in the art within the technical scope disclosed in the present application shall fall within the protection scope of the present application. Therefore, the protection scope of the present application shall be subject to the protection scope of the claims.

What is claimed is:

1. A method for processing a data simulation task, comprising:
obtaining target data of a data simulation task, wherein the data simulation task is simulating Hamiltonian, the target data is Hamiltonian H, and H is represented in a square matrix form and is independent of time;
performing an operation process based on the target data and a specified operation condition, to obtain computing data of the data simulation task, wherein the operation process is computing e^{iA}, the specified operation condition is that A is a square matrix, and A=−Ht, t is a constant, and the computing data is represented in a square matrix form;
decomposing the computing data into a set of finite number of quantum gates; and
constructing, based on the set of the finite number of quantum gates, a quantum circuit to perform simulation, and in a case that a similarity between a circuit matrix corresponding to the quantum circuit and the computing data meets a specified condition, using simulated data obtained through simulation based on the quantum circuit as the target data.

2. The method according to claim 1, wherein the operation process comprises:
performing eigenvalue decomposition or singular value decomposition on the square matrix A to obtain a decomposition result A′; and
computing e^{iA}′ based on a Taylor's formula and an Euler's formula.

3. The method according to claim 1, wherein the computing data is a computation result matrix B, and the decomposing the computing data into a set of finite number of quantum gates comprises:
converting a subscript of a non-zero element in the computation result matrix B into a binary representation form, wherein the computation result matrix B is a square matrix and the non-zero element in the square matrix is a complex number;
expanding each item in the square matrix B and re-representing the square matrix B as a matrix B′ based on the binary representation form of the subscript of the non-zero element in the computation result matrix B; and
determining, based on a value of a sub-item in each item of the matrix B′, a logical gate type corresponding to the sub-item in each item of the matrix B′.

4. The method according to claim 3, wherein the constructing, based on the set of the finite number of quantum gates, a quantum circuit to perform simulation comprises:
determining, based on the logical gate type corresponding to the sub-item in each item of the matrix B′, a quantum sub-circuit and a coefficient corresponding to the quantum sub-circuit, wherein the quantum sub-circuit corresponds to the non-zero element in the computation result matrix B; and
constructing the quantum circuit based on the quantum sub-circuit and the coefficient corresponding to the quantum sub-circuit.

5. The method according to claim 3, wherein the non-zero element in the computation result matrix B is Bₖⱼ, k and j are respectively corresponding to row subscript and column subscript of the non-zero element; S is a set of non-zero elements in the computation result matrix B, s is an iteration indicator of the non-zero elements in the computation result matrix B, and a binary representation form of the subscript of the non-zero elements in the computation result matrix B is as follows:
$${k}^{s} = ( {k}_{1}^{s} , {k}_{2}^{s} , … , {k}_{m}^{s} , … , {k}_{n}^{s} )$$
$${j}^{s} = ( {j}_{1}^{s} , {j}_{2}^{s} , … , {j}_{m}^{s} , … , {j}_{n}^{s} )$$
a representation form of the computation result matrix B is as follows: B=Σₛ^{S}Bₖⱼ|k^{s}><j^{s}|; and
a representation form of the matrix B′ is as follows:
$${B}^{′} = {\sum }_{s}^{S} {B}_{kj} \vert {k}_{1}^{s} 〉 〈 {j}_{1}^{s} \vert ⊗ \vert {k}_{2}^{s} 〉 〈 {j}_{2}^{s} \vert ⊗ … ⊗ \vert {k}_{m}^{s} 〉 〈 {j}_{m}^{s} \vert ⊗ … ⊗ \vert {k}_{n}^{s} 〉 〈 {j}_{n}^{s} \vert ,$$
wherein n is a number of digits obtained after a decimal row subscript or a decimal column subscript is converted into a binary digit, and m is an integer between 1 and n.

6. The method according to claim 3, wherein the value of the sub-item in each item of the matrix B′ is one of |0><0|, |0><1|, |1><0|, and |1><1|; and
the determining, based on a value of a sub-item in each item of the matrix B′, a logical gate type corresponding to the sub-item in each item of the matrix B′ comprises:
determining, based on a correspondence, represented by using the following formula, between the value of the sub-item and the logical gate type, the logical gate type corresponding to the sub-item in each item of the matrix B′,
$$\vert 0 〉 〈 0 \vert = \frac{I + Z}{2}$$
$$\vert 0 〉 〈 1 \vert = \frac{X - iY}{2}$$
$$\vert 1 〉 〈 0 \vert = \frac{X + iY}{2}$$
$$\vert 1 〉 〈 1 \vert = \frac{I - Z}{2}$$
wherein X is a Pauli X gate, Y is a Pauli Y gate, Z is a Pauli Z gate, I is an I gate, and i is an imaginary number.

7. The method according to claim 4, wherein the determining, based on the logical gate type corresponding to the sub-item in each item of the matrix B′, a quantum sub-circuit and a coefficient corresponding to the quantum sub-circuit comprises:
determining the quantum sub-circuit based on the logical gate type corresponding to the sub-item in each item in the matrix B′; and
determining, based on a value of a matrix corresponding to the quantum sub-circuit and a value of a non-zero element in the matrix B′, the coefficient corresponding to the quantum sub-circuit.

8. The method according to claim 7, wherein the determining, based on a value of a matrix corresponding to the quantum sub-circuit and a value of a non-zero element in the matrix B′, the coefficient corresponding to the quantum sub-circuit comprises:
executing a specified division operation, and using an operation result of the division operation as the coefficient corresponding to the quantum sub-circuit, wherein the specified division operation is dividing the value of the non-zero element in the matrix B′ by the value of the matrix corresponding to the quantum sub-circuit.

9. The method according to claim 4, wherein the determining, based on the logical gate type corresponding to the sub-item in each item of the matrix B′, a quantum sub-circuit and a coefficient corresponding to the quantum sub-circuit further comprises:
determining that there are same quantum sub-circuits; and
combining the same quantum sub-circuits, wherein a coefficient of a quantum sub-circuit obtained after the combination is a sum of coefficients corresponding to respective quantum sub-circuits before the combination.

10. The method according to claim 1, wherein the decomposing the computing data into a set of finite number of quantum gates comprises:
confirming that the computing data is a unitary matrix; and
in a case that the computing data is a unitary matrix, decomposing the computing data into a set of single-qubit gates and controlled NOT gates based on a Householder transformation.

11. The method according to claim 1, further comprising:
operating the quantum circuit based on a preset quantum operation object, wherein the preset quantum operation object is an operation instruction set of the quantum circuit.

12. The method according to claim 11, wherein the operation instruction set of the quantum circuit comprises: an instruction for acquiring a matrix corresponding to the quantum circuit; an instruction for assembling the quantum circuit into program code; an instruction for determining that a matrix corresponding to the quantum circuit is a unitary matrix; an instruction for operating the matrix corresponding to the quantum circuit; and an instruction for operating the quantum circuit.

13. The method according to claim 1, wherein the constructing, based on the set of the finite number of quantum gates, a quantum circuit to perform simulation, and in a case that a similarity between a circuit matrix corresponding to the quantum circuit and the computing data meets a specified condition, using simulated data obtained through simulation based on the quantum circuit as the target data comprise:
acquiring a process fidelity from a computation result matrix B to a circuit matrix U based on a dimension of the circuit matrix U corresponding to the quantum circuit or a dimension of the computation result matrix B, the circuit matrix U, and the computation result matrix B, wherein the circuit matrix U corresponding to the quantum circuit is a square matrix;
computing a similarity between the circuit matrix U and the computation result matrix B based on the dimension of the circuit matrix U or the dimension of the computation result matrix B and the process fidelity from the computation result matrix B to the circuit matrix U; and
in a case that the similarity between the circuit matrix U and the computation result matrix B meets a specified condition, using the simulated data obtained through simulation based on the quantum circuit as the Hamiltonian H.

14. The method according to claim 13, wherein the in a case that the similarity between the circuit matrix U and the computation result matrix B meets a specified condition, using the simulated data obtained through simulation based on the quantum circuit as the Hamiltonian H comprises:
in a case that the similarity F_{ave_fid}(B, U) between the circuit matrix U and the computation result matrix B meets the following inequality, using the simulated data obtained through simulation based on the quantum circuit as the Hamiltonian H:
$$\vert {F}_{ave \_ fid} ( B , U ) - 1 \vert < α$$
wherein α is a threshold, and B=e^{-iHt}.

15. The method according to claim 13, wherein the acquiring a process fidelity from a computation result matrix B to a circuit matrix U based on a dimension of the circuit matrix U corresponding to the quantum circuit or a dimension of the computation result matrix B, the circuit matrix U, and the computation result matrix B comprises:
computing a matrix B1, wherein
$$B 1 = \sqrt{\frac{B}{dim ( B )}} ,$$
and dim(B) is a dimension of the computation result matrix B; and
computing a conjugate matrix U1 of the circuit matrix U; and
using a norm value of a dot product of the matrix B1 and the conjugate matrix U1 as the process fidelity from the computation result matrix B to the circuit matrix U.

16. The method according to claim 15, wherein the norm value of the dot product of the matrix B1 and the conjugate matrix U1 is obtained by using the following formulas:
$$res = B 1 \cdot U 1$$
$$res\_vec = ( {res}_{1} , {res}_{2} , … , {res}_{i} , … {res}_{l} )$$
$${‖ res ‖}_{2} = \sqrt{{\sum }_{i}^{l} {res}_{i}^{2}}$$
wherein res is a result of a dot product of the matrix B and the conjugate matrix U1, res_vec is a vector obtained after res is expanded by rows, l is a square of a dimension of the computation result matrix B, and ∥res∥₂ is a norm value of the dot product of the matrix B1 and the conjugate matrix U1.

17. The method according to claim 13, wherein the computing a similarity between the circuit matrix U and the computation result matrix B based on the dimension of the circuit matrix U or the dimension of the computation result matrix B and the process fidelity from the computation result matrix B to the circuit matrix U comprises:
computing the similarity between the circuit matrix U and the computation result matrix B by using the following formulas:
$${F}_{ave \_ fid} ( B , U ) = \frac{{dF}_{state \_ fid} ( B , U ) + 1}{d + 1}$$
$${F}_{state \_ fid} ( B , U ) = {‖ res ‖}_{2}$$
wherein F_{ave_fid}(B, U) is a similarity between the circuit matrix U and the computation result matrix B, and F_{state_fid}(B, U) is a process fidelity between the computation result matrix B and the circuit matrix U.

18. The method according to claim 13, further comprising:
before acquiring the process fidelity from the computation result matrix B to the circuit matrix U, determining that the dimension of the circuit matrix U is consistent with the dimension of the computation result matrix B.

19. An electronic device, comprising a memory and a processor, wherein the memory stores a computer program, and the processor is configured to run the computer program to implement following steps:
obtaining target data of a data simulation task, wherein the data simulation task is simulating Hamiltonian, the target data is Hamiltonian H, and H is represented in a square matrix form and is independent of time;
performing an operation process based on the target data and a specified operation condition, to obtain computing data of the data simulation task, wherein the operation process is computing e^{iA}, the specified operation condition is that A is a square matrix, and A=−Ht, wherein t is a constant, and the computing data is represented in a square matrix form;
decomposing the computing data into a set of finite number of quantum gates; and
constructing, based on the set of the finite number of quantum gates, a quantum circuit to perform simulation, and in a case that a similarity between a circuit matrix corresponding to the quantum circuit and the computing data meets a specified condition, using simulated data obtained through simulation based on the quantum circuit as the target data.

20. A non-transitory computer-readable storage medium, wherein the non-transitory computer-readable storage medium stores a computer program, and the computer program is executed by a processor to implement following steps:
obtaining target data of a data simulation task, wherein the data simulation task is simulating Hamiltonian, the target data is Hamiltonian H, and H is represented in a square matrix form and is independent of time;
performing an operation process based on the target data and a specified operation condition, to obtain computing data of the data simulation task, wherein the operation process is computing e^{iA}, the specified operation condition is that A is a square matrix, and A=−Ht, wherein t is a constant, and the computing data is represented in a square matrix form;
decomposing the computing data into a set of finite number of quantum gates; and
constructing, based on the set of the finite number of quantum gates, a quantum circuit to perform simulation, and in a case that a similarity between a circuit matrix corresponding to the quantum circuit and the computing data meets a specified condition, using simulated data obtained through simulation based on the quantum circuit as the target data.
